(19) United States
(12) Patent Application Publication
(10) Pub. No.: US 2024/0338566 A1
(43) Pub. Date: Oct. 10, 2024

(54) SYSTEM AND METHOD FOR GENERATING A NON-ITERATIVE ARTIFICIAL NEURAL NETWORK

(71) Applicant: Kumar Eswaran, Secunderabad (IN)

(72) Inventor: Kumar Eswaran, Secunderabad (IN)

(73) Assignee: Kumar Eswaran, Secunderabad (IN)

(21) Appl. No.: 18/628,994

(22) Filed: Apr. 8, 2024

(30) Foreign Application Priority Data
Apr. 8, 2023 (IN) 202341026335

(51) Int. Cl. G06N 3/082; G06N 3/042

(52) U.S. Cl. CPC G06N 3/082; G06N 3/042

(57) ABSTRACT

A system and method for generating a non-iterative Artificial Neural Network (ANN) are disclosed. The invention involves obtaining high-dimensional data points within a first high-dimensional space, which are standardized and normalized. Thereafter, a processor performs dimensionality reduction algorithm by determining successive sets of hyperplanes starting from the first high-dimensional space to progressively enhance segregation and isolation of the plurality of data points. The processor further iteratively maps each of the normalized data points from the first high-dimensional space through successive mappings across one or more intermediary low-dimensional spaces before reaching a final low-dimensional space for classification. Finally, the processor generates the ANN by establishing processing nodes that correspond to dimensions across the first high-dimensional space and intermediary low-dimensional spaces. The configuration of the generated ANN is stored for future classification and decision-making applications.

### FIELD OF THE INVENTION

The present invention generally relates to the field of Artificial Intelligence (AI). In particular, the present invention relates to a system and method for generating a non-iterative artificial neural network for tasks involving classification and decision-making.

### BACKGROUND OF THE INVENTION

In the field of AI, classification systems are essential for interpreting complex, multi-dimensional data in various applications, including image processing, speech recognition, medical diagnostics, and robotic perception. These systems largely rely on Artificial Neural Networks (ANNs), which have seen significant advancements through the use of algorithms such as Backpropagation and Deep Learning. Despite their success and widespread use, these systems face several challenges.

One significant challenge is determining an optimal network architecture, including the appropriate number of layers, processing elements within those layers, and the configuration of weights connecting these elements. Traditionally, finding a suitable architecture for an ANN has depended on empirical methods, trial and error, and developer experience. This approach is time-consuming and lacks a systematic method, leading to inefficiencies and potentially suboptimal network performance.

Additionally, the iterative nature of ANN training, particularly with methods like Backpropagation, demands considerable computational resources and time. This training involves repeated adjustments of the network's weights to minimize output errors, a process that can span numerous cycles until achieving satisfactory accuracy. Although effective, this iterative training limits the rapid deployment of neural networks, especially where time and computational efficiency are crucial.

Another issue with current ANN systems is their dependence on large datasets for learning and accurately classifying new instances. While access to substantial datasets is beneficial, it also necessitates more complex and computationally demanding network architectures, complicating the architecture determination process and exacerbating training time and computational efficiency challenges.

In view of the above limitations and challenges, there is a need for a system and method that enables an automatic and efficient determination of neural network architecture, minimizes the dependency on iterative training, and enhances the overall efficiency and accuracy of classification tasks.

### SUMMARY OF THE INVENTION

In an embodiment of the present invention, a system for generating a non-iterative Artificial Neural Network (ANN) for classification and decision-making tasks is provided. The system comprises a database configured to store a dataset of a plurality of high-dimensional data points within a high-dimensional space. The plurality of high-dimensional data points are obtained from one or more sources comprising: digital images, sequences of video frames, audio recordings, medical imaging data, numerical data from lab tests, and environmental data from sensors on robots. A pre-processor is also provided that is configured to standardize and normalize the high-dimensional data points.

The system further comprises a processor to perform dimensionality reduction by determining successive sets of hyperplanes starting from the first high-dimensional space to progressively enhance segregation and isolation of the plurality of data points. The dimensionality reduction is performed by implementing a dimensionality reduction algorithm. In an embodiment of the present invention, the dimensionality reduction algorithm may be KE's sieve algorithm. Each pass of this KE'S sieve algorithm will ensure that each point is separated from every other point, by at least one plane. So, if we run the KE's sieve algorithm k times, one will ensure that every data point is separated from every other point by at least k planes. A higher k results in a greater number of hyperplanes and a finer sieve which separates the data points. Further, the number of hyperplanes in each successive set of hyperplanes, used during the sequence of mappings across the one or more intermediary low-dimensional spaces, is determined based on a logarithmic function of the number of the data points at each stage of mapping from high-dimensional spaces towards the final low-dimensional space.

The processor further maps (non-iteratively) each of the normalized data points from the first high-dimensional space through a sequence of successive mappings across one or more intermediary, possibly lower dimensional, spaces before reaching a final low-dimensional space for classification. To achieve this, the processor first calculates perpendicular distances from each data point to a set of hyperplanes within the first high-dimensional space to other intermediary low-dimensional spaces. Thereafter, the processor by using a sequence of mappings maps data points from the first high-dimensional space through intermediary lower dimensioned spaces to the final low-dimensional space for classification, utilizing the perpendicular distances of a point calculated in one space which are then used to determine the coordinates of the image of the same point in the next space. This process determines the coordinates of the mapped points in other spaces taken one space at time. This process then completely determines the sequence of mappings.

The application of the KE's sieve algorithm determines the number of processing elements and their weights for each layer. For example, the number of processing elements in the first layer is exactly equal to the number of hyperplanes that were obtained by the KE's sieve algorithm to separate the high dimensioned input points. Each processing element represents one hyperplane and its weights are the coefficients of the hyperplane. By the application of the KE's sieve algorithm to separate all the image points in the next mapped space determines the number of processing and their weights for the second layer, and so on, for all the layers till the final layer. It is by this process that the architecture of the ANN is completely generated and thus the ANN can be used to facilitate classification and decision-making tasks. Further, the connections between the processing nodes are weighted based on the coefficients of the hyperplanes from the sets of hyperplanes, enabling efficient encoding of data points into a much-reduced dimensionality for classification. The processor is also configured to generate Orientation Vectors (OVs) for each data point based on characteristics derived from the data point's new representation in the final low-dimensional space, thereby enabling the ANN to facilitate classification tasks.

The system also comprises a memory to store the generated ANN's configuration which includes the processing nodes associated with the hyperplanes for each layer of the ANN, calculated weight matrices and bias terms essential for the generated ANN's operation. The system further comprises a test module which is configured to evaluate accuracy of the ANN configuration stored in the memory against new test data points by applying transformations learned during the ANN's generation to produce OVs for the test data. A classification module is also provided that is configured to classify test data points by performing a bitwise XOR operation between the OVs generated from the test data and OVs derived from the dataset, facilitating the identification of the nearest training data analogue for each test data instance. The classification module then implements a rapid searching algorithm to conduct proximity analysis for identifying nearest neighbour within the dataset based on the results of the XOR operation.

In another embodiment of the present invention, a method for generating a non-iterative ANN for classification and decision-making is provided. The method begins by receiving a plurality of high-dimensional data points within a first high-dimensional space from a dataset. The data points may include digital images, sequences of video frames, audio recordings, medical imaging data, numerical data from lab tests, and environmental data from sensors on robots. The method also involves standardizing and normalizing the received high-dimensional data points as a pre-processing step.

Further, the method comprises determining successive sets of hyperplanes starting from the first high-dimensional space to progressively separate the high-dimension data points from each other by KE's sieve algorithm which could be used as a dimension reducing device. In an embodiment of the present invention, the dimensionality reduction algorithm is KE's sieve algorithm. Further, the number of hyperplanes in each successive set of hyperplanes, used in the sequence of mappings across the one or more intermediary low-dimensional spaces, is determined based on a logarithmic function of the number of the data points at each stage of mapping from high-dimensional spaces towards the final low-dimensional space.

The method also comprises positioning all hyperplanes in the space in such a manner that they partition all the points and ensure that they are all separated from one another by at least one plane. Thereafter, each data point is mapped from the first high-dimensional space across the one or more intermediary dimensioned spaces before reaching a final low-dimensional space for classification. This results in generation of the ANN by establishing processing nodes that correspond to dimensions across the first high-dimensional space and the intermediary low-dimensional spaces, and connecting the processing nodes with weights derived from coefficients of the hyperplanes which are discovered by the KE's sieve algorithm.

The method furthermore comprises storing, in a memory, the generated ANN's configuration, including the processing nodes associated with the hyperplanes for each layer of the ANN, the calculated weight matrices and bias terms essential for the generated ANN's operation. Thereafter, accuracy of the stored ANN configuration is evaluated against new test data points by applying transformations learned during the ANN's generation to produce OVs for the test data. The method also comprises classifying the test data points by performing a bitwise XOR operation between the OVs generated from the test data and OVs derived from the dataset, facilitating the identification of the nearest training data analogue for each test data instance. Finally, the method comprises employing a rapid searching algorithm to conduct proximity analysis for identifying nearest neighbour within the dataset based on the results of the XOR operation.

In yet another embodiment of the present invention, a computer program product is provided. The computer program product comprises a non-transitory computer-readable medium having computer-readable program code stored thereon. The computer-readable program code comprising instructions, that when executed by a processor, causes the processor to receive a plurality of high-dimensional data points within a first high-dimensional space from a dataset. The processor further pre-processes the plurality of high-dimensional data points by standardizing and normalizing. The processor further determines successive sets of hyperplanes starting from the first high-dimensional space to progressively separate the high-dimension data points from each other by employing a dimensionality reduction algorithm. The processor further positions the hyperplanes within the high-dimension space to maximize the distance between the high-dimension data points. The processor further successively maps each data point from the first high-dimensional space through a sequence of mappings across one or more intermediary low-dimensional spaces before reaching a final low-dimensional space for classification. The processor finally generates the ANN by establishing processing nodes that correspond to dimensions across the first high-dimensional space and the intermediary low-dimensional spaces, and connecting the processing nodes with weights derived from coefficients of the hyperplanes.

### BRIEF DESCRIPTION OF THE ACCOMPANYING DRAWINGS

The present invention is described by way of embodiments illustrated in the accompanying drawings wherein:

FIG. 1 is a block diagram illustrating a system 100 to generate a non-iterative Artificial Neural Network (ANN) in accordance with an embodiment of the present invention;

FIGS. 2A and 2B illustrate dimensionality reduction for a plurality of high-dimensional data points from a higher-dimension X-space to a lower-dimension S-space in accordance with an embodiment of the present invention;

FIG. 3 illustrates an ANN representation of a mapping from high-dimensional X-space to q-dimensional S-space in accordance with an embodiment of the present invention. Note in FIG. 3 we depict the case of q=4, hence only 4 processors are shown.

FIGS. 4A and 4B illustrate an Artificial Neural Network (ANN) architecture for the transformation from S-space to U-space and then to the final classification space, V-space, in accordance with an embodiment of the present invention;

FIG. 5 illustrates a method for generating a non-iterative ANN in accordance with an embodiment of the present invention; and

FIG. 6 illustrates an exemplary computer system in which various embodiments of the present invention may be implemented.

### DETAILED DESCRIPTION OF THE INVENTION

The following disclosure is provided to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used are for the purpose of describing exemplary embodiments and should not be considered limiting. Thus, the present invention is to be accorded the widest scope encompassing numerous alternatives, modifications, and equivalents consistent with the principles and features disclosed. For clarity, details relating to technical material that is known in the technical fields related to the invention have not been described in detail so as not to unnecessarily obscure the present invention.

The present invention would now be discussed in the context of embodiments as illustrated in the accompanying drawings.

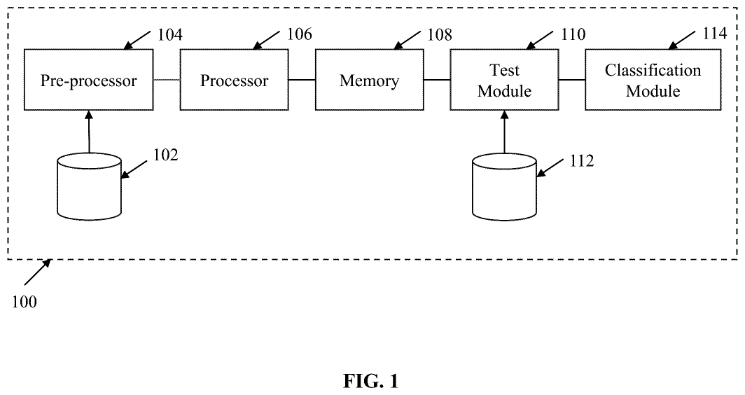

FIG. 1 is a block diagram illustrating a system 100 to generate a non-iterative Artificial Neural Network (ANN) in accordance with an embodiment of the present invention. The non-iterative ANN may be generated for a variety of tasks involving classification and decision-making for a plurality of applications including, but not limited to, image classification, video classification, classification and decision-making from speech data, disease classification from medical data and numerical data, and neural training of robots for specific tasks. The system 100 comprises a database 102, a pre-processor 104, a processor 106, a memory 108, a test module 110, a database 112 and a classification module 114. The database 102 comprises a dataset that comprises a plurality of high-dimensional data points that are to be processed to build the non-iterative ANN. In an embodiment of the present invention, the data points may be in a high-dimensional X-space. In the context of the present invention, the term ‘dimension’ or ‘dimensional’ refers to individual features or attributes that characterize each data point within the dataset. High-dimensional data points are those that encompass a large number of these features, making the dataset complex and challenging to analyse. Further, it may be apparent to a person skilled in the art that the dataset may be a training dataset and the plurality of high-dimensional data points may be in billions in number.

In embodiments of the present invention, for image classification, the plurality of high-dimensional data points may be obtained from digital images, that are represented as a grid of pixels. Each pixel may have multiple dimensions based on color channels e.g., red, green, blue in RGB images. These images may be obtained from digital cameras, smartphones, or image databases. For video classification, the plurality of high-dimensional data points may be derived from sequences of images or frames. Each frame may be like an image in image classification and may be obtained from video capture devices like video cameras, smartphones, or video databases. For classification and decision-making from speech data, high-dimensional speech data points may be obtained from audio recordings sourced from microphones, digital recorders, or audio datasets. For disease classification from medical data, the high-dimensional medical imaging data points may be obtained from medical imaging technology, such as MRI machines, CT scanners, ultrasound devices, or X-ray machines. The medial data points may also include numerical data from lab tests, which can be multi-dimensional based on various measured biomarkers. The plurality of high-dimensional data points for robot training may be obtained from sensors on the robot that collect information about the environment like distance sensors, cameras, and pre-recorded datasets that are used to simulate different scenarios the robot may encounter.

The pre-processor 104 is configured to receive the high-dimensional data points from the database 102 and pre-process it by standardizing and normalizing it before it is sent to the processor 106. The pre-processor 104 may employ one or more known in the art techniques to adjust scale, distribution, and format of the high-dimensional data points, making it uniform across different metrics and dimensions. It may also identify and correct anomalies, such as missing values or outliers in the data.

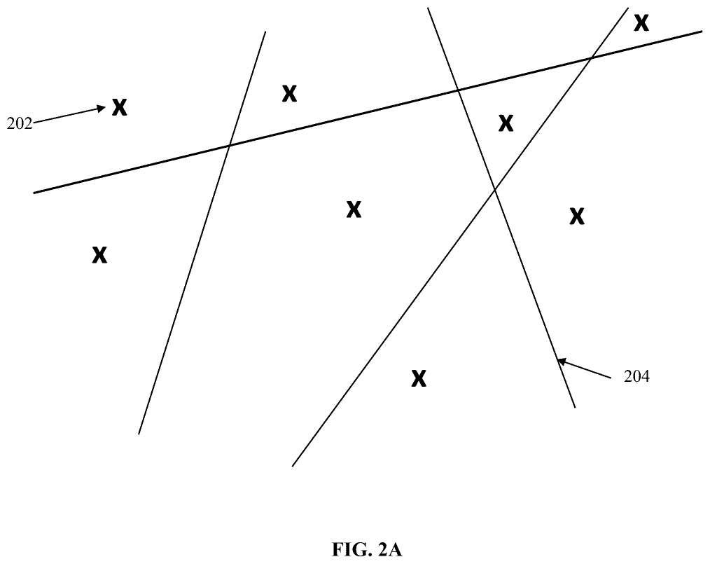

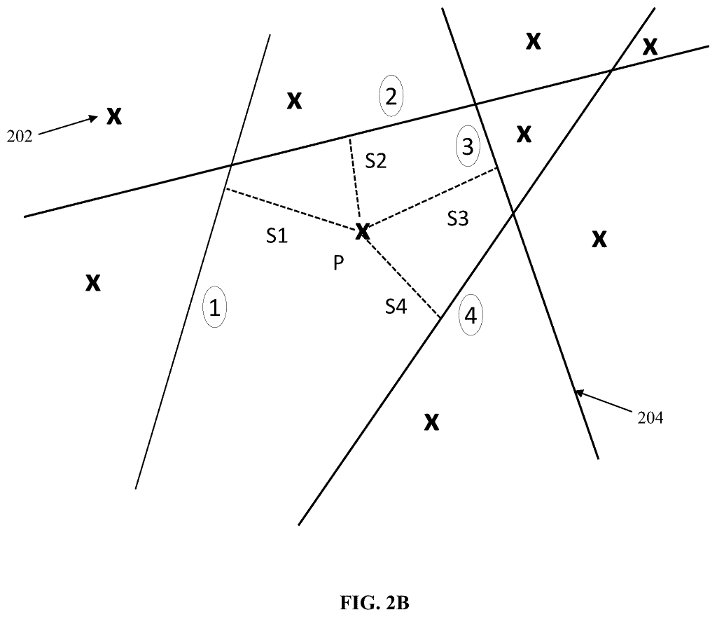

The processor 106 initiates the training phase of the ANN by performing dimensionality reduction of the data points. Dimensionality reduction is employed to simplify the high dimensional data by reducing the number of dimensions in the data, thereby facilitating a more efficient analysis and processing of high dimensional data points without significantly losing informative content. The dimensionality reduction of the data points may be achieved by employing a dimensionality reduction algorithm. In an embodiment of the present invention, the dimensionality reduction algorithm may be KE's sieve algorithm. Further, this training phase involves mapping each data point in the higher-dimensional X-space to a data point in one or more lower-dimensional S-space, to reduce the complexity of the dataset for enhanced analysis and classification. The processor 106 initiates the processing by determining a set of hyperplanes to separate the data points from each other. FIGS. 2A and 2B illustrate the dimensionality reduction for the high-dimensional data points, denoted as 202, from a higher-dimension X-space to a lower-dimension S-space in accordance with an embodiment of the present invention. Each of the data points 202 labelled x, is partitioned by one or more hyperplanes 204 as determined by the dimensionality reduction algorithm. These hyperplanes 204 separate the data points ‘x’ from one another, categorizing the dataset into distinct sections for further analysis. In an embodiment of the present invention, the number ‘q’ of hyperplanes needed for this separation is based on a logarithmic function of the number of data points (N), such that q=O(log(N)). Thus, the requirement of the number ‘q’ of hyperplanes is much less as ‘q’ grows slowly compared to ‘N’. As can be seen from FIGS. 2A and 2B, the hyperplanes 204 are positioned within the X-space to best localize the points 202 and make them distinguishable (separable) from one another, thereby simplifying the structure of the dataset and preparing it for the subsequent mapping to a lower-dimensional space S-space.

In an embodiment of the present invention, the processor 106 may employ the dimensionality reduction algorithm by repeated use of the KE algorithm referred to as passes. Each pass involves the algorithm systematically determining a new or successive sets of hyperplanes starting from the first high-dimensional space to progressively enhance segregation and isolation of the plurality of data points. The initial pass may generate a specific set of hyperplanes, indicated by q1, which provides the initial separation. Subsequent passes, denoted by q2, q3, and so on, introduce additional or successive hyperplanes, each enhancing the granularity of the data point partitioning. This process repeated m times (m passes), builds a sophisticated sieve-like structure within the high-dimensional space, ensuring a granular separation where every pair of data points is divided by several hyperplanes, collectively represented by the sum q=q1+q2+ . . . +qm. The multi-pass approach enables the ANN to be applied to various applications, from simple to highly complex classification problems.

Further, the first hyperplane may be mathematically defined by equation 1 a₁x₁+a₂x₂+ . . . +aₙxₙ+d₁=0. If a data point does not lie on this hyperplane, equation 2 s₁=C(a₁x₁+a₂x₂+ . . . +aₙxₙ+d₁), where C is a constant and C=−1/√a₁²+a₂²+a₃²+ . . . aₙ², determines the perpendicular distance of a point P whose coordinates are (x₁, x₂, . . . , xₙ) from the hyperplane, which is used in mapping to q-dimensional S-space. Further, the coefficients of the hyperplanes may be rewritten such that w₁₁=C.a₁, w₁₂=C.a₂, . . . w₁₀=C.d₁ such that equation 2 becomes s₁=w₁₁x₁+w₁₂x₂+ . . . w₁ₙxₙ+w₁₀ (equation 3).

Thereafter, the processor 106 maps every point P, one at a time, in the higher dimensional X-space to a point P′ in a lower dimensional S-space. To achieve this, the processor 106 calculates the perpendicular distances from the data point P to each of the q hyperplanes. As illustrated above with respect to equation 3, these distances may be represented as s₁=w₁₁x₁+w₁₂x₂+ . . . +w₁ₙxₙ+w₁₀ (equation 4), s₂=w₂₁x₁+w₂₂x₂+ . . . +w₂ₙxₙ+w₂₀ (equation 5), s₃=w₃₁x₁+w₃₂x₂+ . . . +w₃ₙxₙ+w₃₀ (equation 6), and s₄=w₄₁x₁+w₄₂x₂+ . . . +w₄ₙxₙ+w₄₀ (equation 7) for the illustrative case of q=4. These equations are used to transform the input variables x₁, x₂ . . . , xₙ into the output variables s₁, s₂, s₃, . . . , s_{q}, thus reducing the dimensionality of the of the data points or the data set.

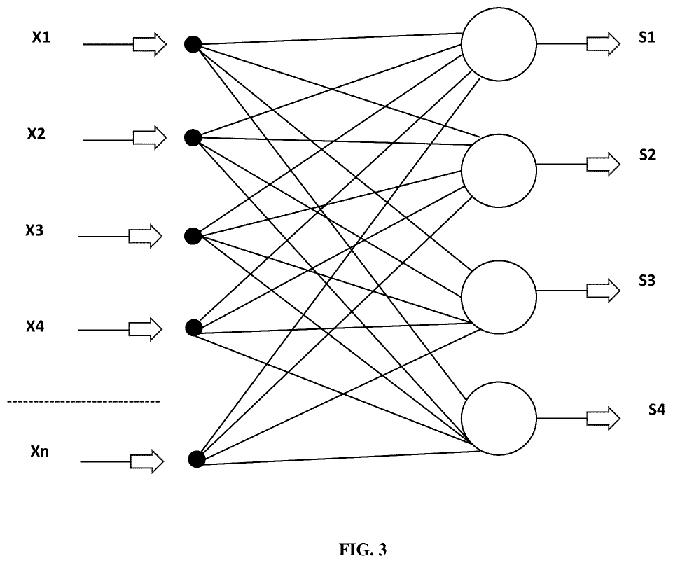

FIG. 3 illustrates architecture of an ANN representing mapping from a first high-dimensional X-space to a successive series of lower-dimensional spaces i.e. q-dimensional S-space in accordance with an embodiment of the present invention. In an exemplary embodiment of the present invention, the ANN representation is for the case when q=4 representing the final low-dimensional space for classification. This mapping employs successive sets of hyperplanes determined by the dimensionality reduction algorithm to progressively enhance the segregation and isolation of the plurality of data points. Each input node x₁, x₂ . . . , xₙ corresponds to a dimension in X-space. These nodes, known as processing nodes, are fully connected to a layer of q nodes that represent the S-space dimensions s₁, s₂, s₃ . . . , s_{q}, where the weights of the connections are the coefficients of the hyperplanes as determined by the dimensionality reduction algorithm. The output of each processing node is the calculated perpendicular distance from each of the plurality of the hyperplanes or data points' transformed characteristics in the S-space, encoding them in a reduced dimensionality that retains the distinctiveness of the data while reducing its complexity for subsequent processing steps.

For clarification, it may be iterated, that the ANN's generation is structured through organizing these processing nodes into layered configurations, representing the sequence of mappings from the first high-dimensional space through intermediary lower-dimensional spaces to the final low-dimensional S-space. This includes an input layer, capturing high-dimensional data; one or more intermediary layers, where data undergoes further processing and dimensionality reduction via hyperplanes; and an output layer, deriving the final classification or decision-making outcome.

Further, in an embodiment of the present invention, the processor 106 may facilitate the extension of the dimensionality reduction process to encompass additional mappings. This may be achieved by repeatedly applying the dimensionality reduction algorithm to create successive layers within the ANN. Initially, the high-dimensional input data in X-space is fed into the dimensionality reduction algorithm. In the first layer or S-space, the data is separated by a new set of plurality of hyperplanes, which are generated by the dimensionality reduction algorithm. These newly formed hyperplanes constitute the ANN's processing nodes in the S-space layer, and the orthogonal distances from each training data point to these hyperplanes are computed, yielding S-vector, indicative of the data's coordinates in S-space.

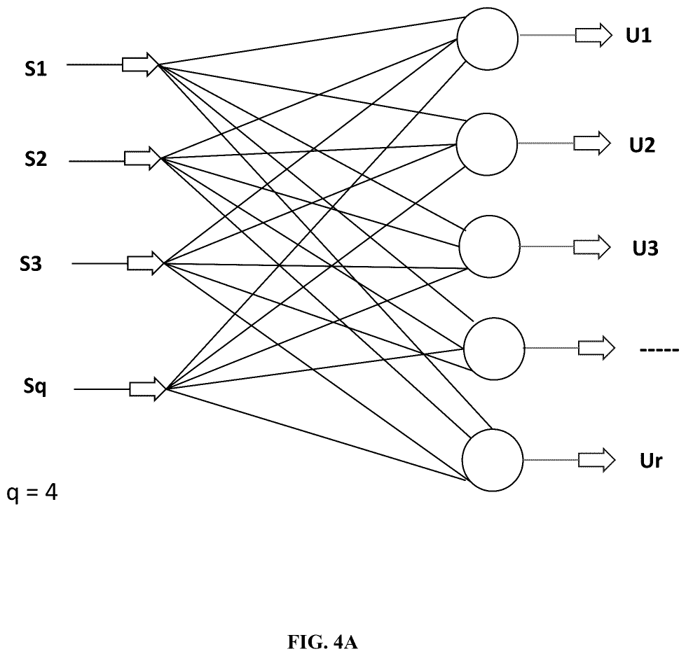

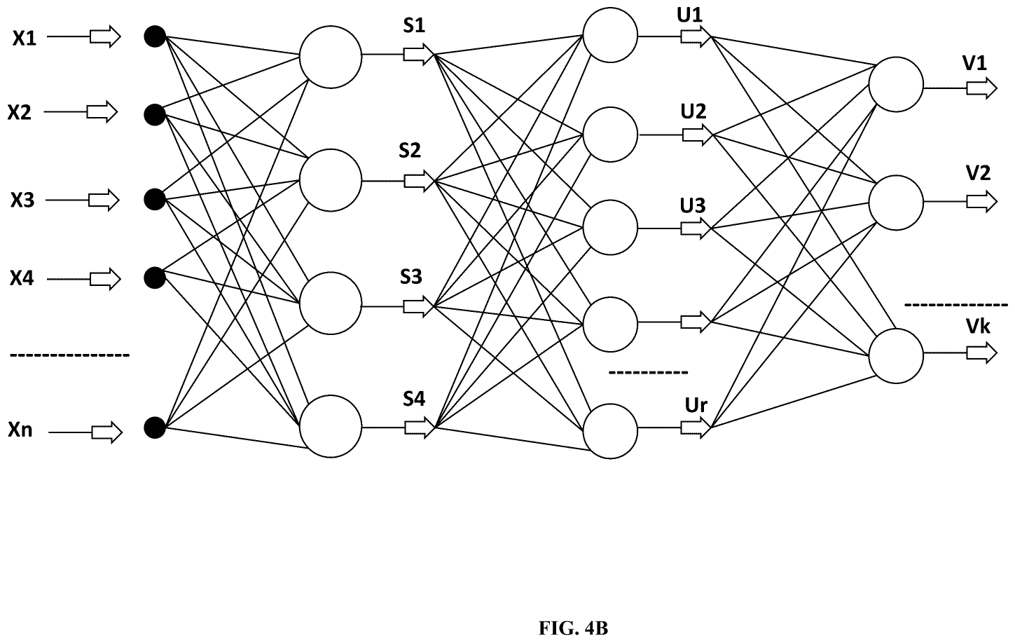

Referring now to FIG. 4A which depicts an ANN architecture that illustrates the subsequent transformation from S-space to a further reduced dimensional space, U-space. FIG. 4A illustrates the iterative process of mapping data points from a high-dimensional space through intermediary spaces, culminating in U-space. Further, FIG. 4A shows the architecture by which the data points, having already been mapped to the S-space dimensions, are further processed by additional hyperplanes. The result of this processing is a new set of transformed data points, now situated within U-space, which will subsequently be input to the final low-dimensional space or layer of the ANN for further transformation.

FIG. 4B depicts the ANN's architecture that facilitates the final transformation from higher dimension U-space to the final low-dimensional space used for classification, denoted as V-space. The transformation follows the successive mappings from the first high-dimensional space, X-space, through intermediary spaces including S-space and U-space, culminating in the final low-dimensional V-space. In FIG. 4B, the transformation process ends with the generation of a set of features for each data point within V-space. These features, derived from the data's interaction with the final set of hyperplanes in the ANN, are used to compute Orientation Vectors (OVs) for each data point. The OVs, act as binary representations of each data point's transformed characteristics within V-space, are subsequently used for the classification process, as they provide a simplified representation of the data, facilitating efficient classification through comparison with OVs from training set using XOR operations, thus signifying the neural network's final output in the processing sequence.

After the ANN has been created or established through successive layers of processing, the generated ANN model, including its configuration such as the processing nodes, the calculated weight matrices, and bias terms, is stored within the memory 108 for various future applications. This storage may include the entirety of the model's architecture, the processing nodes corresponding to the hyperplanes across all layers, the weight matrices that have been determined during training, and the bias terms that offset each node's activation. The memory 108 may be designed to facilitate quick retrieval and efficient utilization of the ANN model, ensuring that the model's accuracy and computational efficiency are maintained when applied to subsequent tasks.

In an embodiment of the present invention, the ANN model is tested where the robustness and accuracy of the stored ANN model are evaluated against new, unseen test data. The test module 110 is configured to test the generated ANN model with test data points obtained from the database 112. The test data points mirror the structure and dimensionality of the training data and is propagated through the ANN, undergoing the same transformations from X-space to V-space as discussed in connection with FIGS. 2A to 4B. During the testing phase, the ANN model applies the learned transformations to the test data to produce corresponding OVs, as it did during training.

The classification module 114 is configured to perform a bitwise XOR operation on the OVs to discern the test data's classification. The classification module 114 determines the test data's similarity to the training data classes, based on the unique pattern of zeros and ones within the OVs. The XOR comparison facilitates identifying even minute differences between the vectors, thus enabling a precise and computationally efficient classification process. Further, to facilitate the classification, the classification module 114 may employ a rapid searching algorithm to locate nearest neighbour within the training dataset for each test data point. The rapid searching algorithm may be optimized to handle the binary nature of the OVs, allowing for a swift traversal through the large search space. The nearest neighbour search may pinpoint the most similar training data OV for each test data OV, (this similarity can be easily be determined by taking dot products between a test sample OV and all train samples OVs), thereby assigning the most probable class to each test instance.

Upon the XOR operations' completion and the nearest neighbour determinations, the ANN may output a classification label for each piece of test data, which may correspond to the class of its nearest training data neighbour. These classifications may facilitate in further analysis, decision-making processes, or direct application in the end-user scenarios, highlighting utility of the ANN in a plurality of fields ranging from image and video classification to complex decision-making systems.

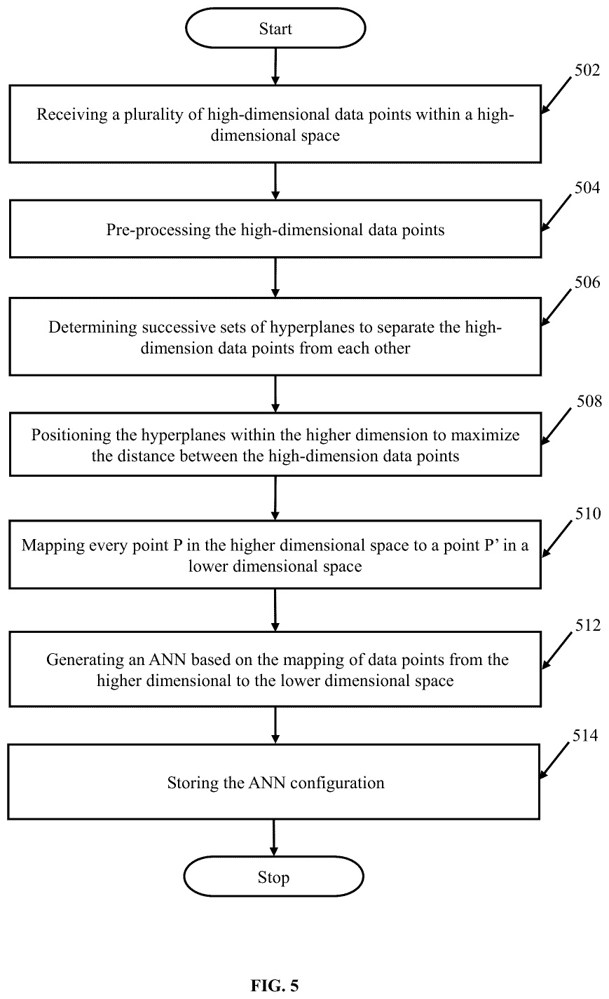

FIG. 5 illustrates a method 500 for generating a non-iterative ANN in accordance with an embodiment of the present invention. The non-iterative ANN may be generated for a variety of tasks involving classification and decision-making for a plurality of applications including, but not limited to, image classification, video classification, classification and decision-making from speech data, disease classification from medical data and numerical data, and neural training of robots for specific tasks.

At step 502, a plurality of high-dimensional data points are received within a first high-dimensional space to train and build the ANN. In an embodiment of the present invention, the received plurality of data points may be in a high-dimensional X-space. In embodiment of the present invention, the plurality of high-dimensional data points may be obtained from digital images from digital cameras, smartphones, or image databases for image classification, frame sequences from videos for video classification, audio recordings from microphones, digital recorders, and audio datasets for speech analysis, medical imaging data from MRI machines, CT scanners, ultrasound devices, and X-ray machines for disease classification, and environmental data from cameras, pre-recorded datasets and sensors on robots for neural training.

At step 504, the high-dimensional data points pre-processed by standardizing and normalizing them before they are processed to train and build the ANN. In exemplary embodiment of the present invention, one or more known in the art techniques to adjust scale, distribution, and format of the high-dimensional data points may be employed to make them uniform across different metrics and dimensions. Anomalies such as missing values or outliers may also be identified and corrected.

At step 506, successive sets of hyperplanes are determined starting from the first high-dimensional space to separate the high-dimension data points from each other. The determination of the hyperplanes is achieved by a dimensionality reduction algorithm. In an embodiment of the present invention, the number ‘q’ of hyperplanes needed for this separation is based on a logarithmic function of the number of data points (N), such that q=O(log (N)). In an embodiment of the present invention, the dimensionality reduction algorithm may be KE's sieve algorithm.

At step 508, the hyperplanes are positioned within the higher dimension X-space to localise each data point and partitioning them from other points, thereby simplifying the structure of the dataset and preparing it for the subsequent mapping to a lower-dimensional space S-space. The separation of the high-dimensional data points facilitates categorization of the dataset into distinct sections for further analysis. In an embodiment of the present invention, the dimensionality reduction algorithm, in a series of iterative steps, may draw a new set of hyperplanes within the X-space for further segregation and isolation each high-dimensional input data point, ensuring that every point is uniquely positioned in its distinct segment of space. A first iteration step by the dimensionality reduction algorithm may generate a specific set of hyperplanes, indicated by q1, which may provide the initial separation. Subsequent passes generate hyperplanes numbering q2, q3, and so on such that q=q1+q2+ . . . +qm. These additional hyperplanes, enhance the granularity of the data point partitioning.

At step 510, every point P in the higher dimensional X-space is mapped to a point P′ in a lower dimensional S-space through a mapping. To achieve this, perpendicular distances from the data point P to each of the q hyperplanes are determined. These distances are may be represented as s₁=w₁₁x₁+w₁₂x₂+ . . . +w₁ₙxₙ+w₁₀, s₂=w₂₁x₁+w₂₂x₂+ . . . +w₂ₙxₙ+w₂₀, s₃=w₃₁x₁+w₃₂x₂+ . . . +w₃ₙxₙ+w₃₀, and s₄=w₄₁x₁+w₄₂x₂+ . . . +w₄ₙxₙ+w₄₀ for the illustrative case of q=4. These equations are used to transform the input variables x₁, x₂ . . . , xₙ into the output variables s₁, s₂, s₃ . . . s_{q}, thus reducing the dimensionality of the of the data points or the data set.

At step 512, an architecture of the ANN is generated based on the mapping of data points from higher dimensional X-space to a q-dimensional S-space. Each input node of the ANN x₁, x₂ . . . , xₙ corresponds to a dimension in X-space. These nodes are fully connected to a layer of q nodes that represent the S-space dimensions s₁, s₂, s₃ . . . , s_{q}, where the weights of the connections are the coefficients of the hyperplanes as determined by the dimensionality reduction algorithm. Further, output of each of the q nodes of the ANN is the calculated perpendicular distance from the hyperplanes.

In an embodiment of the present invention, the dimensionality reduction process may be extended to encompass additional mappings from higher dimensional space to one or more lower dimensional spaces. This may be achieved by repeatedly applying the dimensionality reduction algorithm to create successive layers within the ANN. This process results in a transformation from S-space to a further reduced dimensional space, U-space and from the final transformation from U-space to V-space i.e., the last feature space that is used for classification. Further, these features, derived from the data's interaction with the final set of hyperplanes in the ANN, are used to compute OVs for each data point. The OVs are binary representations of the data's position relative to the hyperplanes in V-space. These OVs are subsequently used for the classification process as they provide a simplified representation of the data, facilitating efficient classification through comparison with OVs from the training set using XOR operations, thus signifying the neural network's final output in the processing sequence.

At step 514, after the ANN has been created or established through successive layers of processing, the ANN model is stored within a memory for various future applications. This storing of the ANN may include the entirety of the model's architecture or configuration which includes the processing nodes corresponding to the hyperplanes across all layers, the weight matrices that have been determined during training, and the bias terms that offset each node's activation or facilitate the ANN's operation. The storing of the ANN may be designed to facilitate quick retrieval and efficient utilization of the ANN model, ensuring that the model's accuracy and computational efficiency are maintained when applied to subsequent tasks.

In an embodiment of the present invention, the generated ANN model may be tested or evaluated for robustness and accuracy. During testing, the ANN model may be evaluated against new, unseen test data. The ANN may be tested with test data that may mirror the structure and dimensionality of the training data. The test data points may be propagated through the ANN, undergoing the same transformations from X-space to V-space as discussed above. During the test, the ANN model may apply the learned transformations to the test data to produce corresponding OVs, as it did during training.

Thereafter, OVs are derived from the test data to be scrutinized for classification. This process begins by executing bitwise XOR operations between the OVs of the test data and those from the training dataset to identify differences and similarities to ascertain the closest match for each test data instance. Following the XOR operation, a proximity analysis is conducted within a multidimensional vector space. This involves assessing the similarities or disparities between the XOR operation results to determine the most closely aligned training data counterpart for each piece of test data. Such proximity analysis enables a precise and computationally efficient classification by accurately identifying the nearest neighbour within the training dataset based on the most similar or least difference, as indicated by the XOR comparison. The outcome of these operations results in assigning a classification label to each unit of test data, reflective of its nearest training data analogue. These classification labels may then be utilized for further analysis, decision-making processes, or direct application by the ANN, enhancing its ability to accurately interpret and classify new data.

Further, the ANN constructed by the present invention was tested for 2 applications for its efficacy. In the first application, the ANN was able to distinguish between different animated characters with high precision. It successfully classified each frame, effectively differentiating the unique features of characters across a variety of scenes and episodes, despite the potential variations in animation style and background context. The ANN processed 14,179 frames by segmenting them using a series of hyperplanes, thereby efficiently reducing the dimensionality through the X-space to S-space, and finally to U-space. This precise mapping led to the computation of OVs for a substantial number of frames, enabling an impressively accurate classification result. The outcome of this application saw an exceptionally high classification accuracy rate of 97.21% for sequences of test frames.

In the second application, UCF 101 Dataset, known for its comprehensive range of human activities, was used to evaluate the ANN. The dataset consists of a wide variety of video clips depicting different human actions. The ANN was trained using a subset of frames, totaling 2,54,130 from the dataset, to classify activities within the videos. For validation, the ANN's performance was assessed against a set of 22,67,000 test frames. These test frames were distinct from the training set to ensure an objective evaluation of the ANN's classification performance. The ANN achieved a classification accuracy of 94.31%, demonstrating its effectiveness in distinguishing and categorizing diverse human actions from video data.

Thus, the present invention introduces a novel and inventive approach to classification and decision-making tasks through a non-iterative ANN. This invention significantly improves the efficiency and effectiveness of ANNs by employing a dimensionality reduction technique that systematically identifies the optimal architecture for the neural network. Unlike traditional neural network algorithms that rely on iterative processes, extensive training, and testing times, this invention automatically determines the precise number of processing elements needed for each layer and their corresponding weights. This capability not only streamlines the network's architecture, making it more compact and requiring fewer hyperplanes for data segregation but also substantially reduces the training time. Furthermore, the neural network architecture developed by the system and method of the present invention is supported by a strong mathematical foundation, ensuring accuracy and reliability. By addressing and overcoming the limitations of existing neural network methodologies, such as the dependency on trial and error for architecture optimization, the present invention presents a technical solution that significantly advances the field of artificial intelligence, offering a more efficient, precise, and scalable method for solving a wide array of classification problems across different domains.

The efficiency of the present invention may be further illustrated by examining functioning of a processing element. Suppose there are only 3 processing elements and each of them receives the same n inputs (x₁, x₂, . . . , xₙ). It has been discussed above in context of FIGS. 1, 2A and 2B that each of these 3 processing elements takes a weighted average of the inputs and outputs the values (s₁, s₂, s₃), which are given by the equations (4)-(6) i.e. s₁=w₁₁x₁+w₁₂x₂+ . . . +w₁ₙxₙ+w₁₀, s₂=w₂₁x₁+w₂₂x₂+ . . . +w₂ₙxₙ+w₂₀, and s₃=w₃₁x₁+w₃₂x₂+ . . . +w₃ₙxₙ+w₃₀. This means that each processing element actually represents one hyperplane and the weights wᵢⱼ are the coefficients of the hyperplane. Since there are three processing elements there are three hyperplanes. Thus, these hyperplanes are fixed, do not depend on the input variables and each of them is associated with one of the processing elements. Further, it has been disclosed above that for large n-dimension space the number of hyperplanes, q required to separate N points is given by q≅O(log₂N), which is not a large number. Since every hyperplane is represented by a single processing element this means that with q processing elements one can distinguish N=2^{q} sample points, this can be interpreted as a number of patterns. This is the reason why the present invention is very efficient, because even with a few processing elements classification of huge data is possible.

The present invention may further be discussed in aspect of a comparison of artificial neurons and the natural neurons in a human brain. The neurons in the brain are small cells that receive information in the form of minute charges from sensors and other neurons, and by travelling through dendrites (which act like ‘wires’) arrive at the membranes of the cell body where they are assimilated and pass through the axon of the neuron to be sent across to other neurons. It may be apparent to a person of ordinary skill in the art that Hodgkin-Huxley equations are differential equations which determine the number of cations and anions that travel to the cell of a neuron and thus determine the voltage level that it reaches. However for the purposes of illustration, it is assumed that to a first approximation each neuron behaves like a minute capacitance and the voltage that it attains depends upon the input charges (x₁, x₂, x₃, . . . , xₙ), these inputs are in the form of minute charges that are sent from sensors in the body or from other neurons. If the total magnitude of charges reach a particular value then the voltage of the neuron is raised above its threshold and it emits an output charge. If the voltage is less than the threshold the charge may slowly decay unless replenished by subsequent inputs. So a neuron which is a cell behaves electrically like a capacitance. Thus, the natural neurons may be assumed as a network of capacitances connected to each other.

It would now be shown that each natural neuron, to a first approximation, behaves like an artificial neuron i.e. it can be associated to a unique n-dimensional hyperplane with every natural neuron which has input charges (x₁, x₂, x₃, . . . , xₙ). Thus, the output s of such a neuron will be the perpendicular distance of the point (x₁, x₂, x₃, . . . , xₙ) from its own hyperplane. Therefore, it can be assumed that the output s is a function of the n inputs i.e. s=f(x₁, x₂, x₃, . . . , xₙ), where f is some unknown function. Since the charges are minute (near zero), the function may be expanded about its threshold value by using a Taylor series expansion i.e.:

$$s = w 0 + x 1 \frac{\partial f}{\partial x 1} + x 2 \frac{\partial f}{\partial x 2} + x 3 \frac{\partial f}{\partial x 3} + … + xn \frac{\partial f}{\partial xn}$$

Since the derivatives are to be evaluated about the point x₁=x₂=x₃= . . . =xₙ=0, they are all constants, so the relationship of the output charges of a neuron which receives small charges (x₁, x₂, x₃, . . . , xₙ), is: s=w₀+w₁x₁+w₂x₂+w₃x₃+ . . . +wₙxₙ which is the equation of a hyperplane. Thus, it has been proved that every natural neuron can be associated by a unique hyperplane. The outputs of a neuron is proportional to the perpendicular distance of the input point (x₁, x₂, x₃, . . . , xₙ) from its own hyper-plane. An aspect very similar to that of artificial processing elements used in ANN computations.

Consequently, it has been demonstrated that both artificial and natural neurons are representable via hyperplanes, underscoring a fundamental aspect of the present invention. Upon further examination, inputs (x₁, x₂, x₃, . . . , xₙ) directed towards distinct neurons exhibit differential weights-coefficients of the hyperplane attributable to the conductivity of the dendrites to which they are connected. This approximation, though simplified, clears a significant observation: despite the seemingly modest count of neurons in the human brain, which are approximately 86 billion, with each neuron interfacing with approximately ten thousand others, the brain's capacity to process and recognize a vast array of patterns (numbering in the quintillions) is disproportionately huge by several orders of magnitude. This capacity is rationalized by the relationship in a high-dimensional space, which is approximately dimensioned 10,000 (per neuron), that the number of patterns, N, is correlated to the number of neurons, q, by the function q≅O(log₂N), thereby deducing N=2^{q}. This delineation underscores the potential for a significantly large number of patterns, highlighting the extraordinary computational efficiency of the human brain. Conversely, the nematode Caenorhabditis elegans, with a mere 302 neurons within its nervous system, demonstrates effective functionality, showcasing the intrinsic complexity of neural systems.

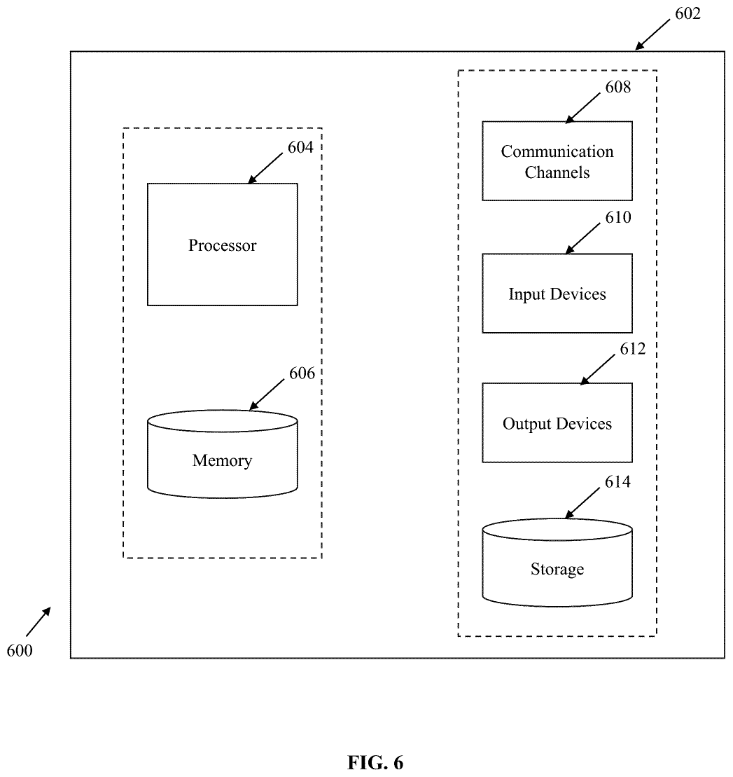

FIG. 6 illustrates an exemplary computer system in which various embodiments of the present invention may be implemented. The computer system 602 comprises a processor 604 and a memory 606. The processor 604 executes program instructions and is a real processor. The computer system 602 is not intended to suggest any limitation as to scope of use or functionality of described embodiments. For example, the computer system 602 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 606 may store software for implementing various embodiments of the present invention. The computer system 602 may have additional components. For example, the computer system 602 includes one or more communication channels 608, one or more input devices 610, one or more output devices 612, and storage 614. An interconnection mechanism (not shown) such as a bus, controller, or network, interconnects the components of the computer system 602. In various embodiments of the present invention, operating system software (not shown) provides an operating environment for various software executing in the computer system 602, and manages different functionalities of the components of the computer system 602.

The communication channel(s) 608 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 610 may include, but not limited to, a keyboard, mouse, pen, joystick, trackball, a voice device, a scanning device, touch screen or any another device that is capable of providing input to the computer system 602. In an embodiment of the present invention, the input device(s) 610 may be a sound card or similar device that accepts audio input in analog or digital form. The output device(s) 612 may include, but not limited to, a user interface on CRT or LCD, printer, speaker, or any other device that provides output from the computer system 602.

The storage 614 may include, but not limited to, magnetic disks, magnetic tapes, CD-ROMs, CD-RWs, DVDs, flash drives or any other medium which can be used to store information and can be accessed by the computer system 602. In various embodiments of the present invention, the storage 614 contains program instructions for implementing the described embodiments.

The present invention may suitably be embodied as a computer program product for use with the computer system 602. The method described herein is typically implemented as a computer program product, comprising a set of program instructions which is executed by the computer system 602 or any other similar device. The set of program instructions may be a series of computer readable codes stored on a tangible medium, such as a computer readable storage medium (storage 614), for example, diskette, CD-ROM, ROM, flash drives or hard disk, or transmittable to the computer system 602, via a modem or other interface device, over either a tangible medium, including but not limited to optical or analogue communications channel(s) 608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

I/We claim:

1. A system for generating a non-iterative Artificial Neural Network (ANN) for classification and decision-making tasks, the system comprising:
a dataset comprising a plurality of data points within a first high-dimensional space;
a pre-processor configured to standardize and normalize the data points;
a processor configured to perform dimensionality reduction by:
determining successive sets of hyperplanes starting from the first high-dimensional space to progressively enhance segregation and isolation of the plurality of data points;
successively mapping each of the normalized data points from the first high-dimensional space through many successive mappings across one or more intermediary low-dimensional spaces before reaching a final low-dimensional space for classification; and
generating the ANN by establishing processing nodes that correspond to dimensions across the first high-dimensional space and intermediary low-dimensional spaces, thereby enabling the generated ANN to facilitate classification and decision-making tasks.

2. The system of claim 1, wherein the plurality of data points in the dataset are obtained from one or more sources comprising: digital images, sequences of video frames, audio recordings, medical imaging data, numerical data from lab tests, and environmental data from sensors on robots.

3. The system of claim 1, wherein the dimensionality reduction is performed by implementing a dimensionality reduction algorithm.

4. The system of claim 3, wherein the dimensionality reduction algorithm is KE's sieve algorithm.

5. The system of claim 1, wherein number of hyperplanes in each successive set of hyperplanes, used during the many mappings across the one or more intermediary low-dimensional spaces, is determined based on a logarithmic function of the number of the data points at each stage of mapping from high-dimensional spaces towards the final low-dimensional space.

6. The system of claim 1, wherein the processor is configured to calculate perpendicular distances from each data point to a set of hyperplanes within the first high-dimensional space and continuing this process for intermediary low-dimensional spaces, facilitating the dimensionality reduction by the successive mappings towards the final low-dimensional space.

7. The system of claim 6, wherein the processor is configured to map data points from the first high-dimensional space through intermediary low-dimensional spaces to the final low-dimensional space for classification, utilizing the calculated perpendicular distances to progressively reduce the dimensionality of the data points in each mapping stage.

8. The system of claim 7, wherein connections between the processing nodes are weighted based on the coefficients of the hyperplanes from the sets of hyperplanes, enabling efficient encoding of data points into a reduced dimensionality for classification.

9. The system of claim 6, wherein the processor is configured to generate Orientation Vectors (OVs) for each data point based on characteristics derived from the data point's new representation in the final low-dimensional space, thereby enabling the ANN to facilitate classification tasks.

10. The system of claim 1, further comprising a memory configured to store the generated ANN's configuration, including the processing nodes associated with the hyperplanes for each layer of the ANN, calculated weight matrices and bias terms essential for the generated ANN's operation.

11. The system of claim 10 further comprises a processor-implemented test module configured to evaluate accuracy of the ANN configuration stored in the memory against new test data points by applying transformations learned during the ANN's generation to produce OVs for the test data.

12. The system of claim 11 further comprises a processor-implemented classification module configured to classify test data points by performing a bitwise XOR operation between the OVs generated from the test data and OVs derived from the dataset, facilitating the identification of the nearest training data analogue for each test data instance.

13. The system of claim 10, wherein the processor-implemented classification module implements a rapid searching algorithm to conduct proximity analysis for identifying nearest neighbour within the dataset based on the results of the XOR operation.

14. A method for generating a non-iterative Artificial Neural Network (ANN) for classification and decision-making tasks, the method comprising:
receiving a plurality of high-dimensional data points within a first high-dimensional space from a dataset;
pre-processing the plurality of high-dimensional data points by standardizing and normalizing;
determining successive sets of hyperplanes starting from the first high-dimensional space to progressively separate the high-dimension data points from each other by employing a dimensionality reduction algorithm;
positioning the determined sets of hyperplanes within the high-dimension space to maximize the distance between the high-dimension data points;
mapping successively each data point from the first high-dimensional space across one or more intermediary low-dimensional spaces before reaching a final low-dimensional space for classification; and
generating the ANN by establishing processing nodes that correspond to dimensions across the first high-dimensional space and the intermediary low-dimensional spaces, and connecting the processing nodes with weights derived from coefficients of the hyperplanes.

15. The method of claim 14, wherein receiving the plurality of high-dimensional data points includes obtaining the data points from one or more sources comprising: digital images, sequences of video frames, audio recordings, medical imaging data, numerical data from lab tests, and environmental data from sensors on robots.

16. The method of claim 14, wherein the dimensionality reduction algorithm is KE's sieve algorithm.

17. The method of claim 14, wherein number of hyperplanes in each successive set of hyperplanes, used during the sequence of successive mappings across the one or more intermediary low-dimensional spaces, is determined based on a logarithmic function of the number of the data points at each stage of mapping from high-dimensional spaces towards the final low-dimensional space.

18. The method of claim 14 further comprises storing, in a memory, the generated ANN's configuration, including the processing nodes associated with the hyperplanes for each layer of the ANN, calculated weight matrices and bias terms essential for the generated ANN's operation.

19. The method of claim 18 further comprises evaluating accuracy of the stored ANN configuration against new test data points by applying transformations learned during the ANN's generation to produce OVs for the test data.

20. The method of claim 19 further comprises classifying the test data points by performing a bitwise XOR operation between the OVs generated from the test data and OVs derived from the dataset, facilitating the identification of the nearest training data analogue for each test data instance.

21. The method of claim 20 further comprises employing a rapid searching algorithm to conduct proximity analysis for identifying nearest neighbour within the dataset based on the results of the XOR operation.

22. A computer program product comprising:
a non-transitory computer-readable medium having computer-readable program code stored thereon, the computer-readable program code comprising instructions, that when executed by a processor, cause the processor to:
receive a plurality of high-dimensional data points within a first high-dimensional space from a dataset;
pre-process the plurality of high-dimensional data points by standardizing and normalizing;
determine successive sets of hyperplanes starting from the first high-dimensional space to progressively separate the high-dimension data points from each other by employing a dimensionality reduction algorithm;
position the hyperplanes within the high-dimension space to partition and localize the high-dimension data points;
iteratively map each data point from the first high-dimensional space through iterative mappings across one or more intermediary low-dimensional spaces before reaching a final low-dimensional space for classification; and
generate the ANN by establishing processing nodes that correspond to dimensions across the first high-dimensional space and the intermediary low-dimensional spaces, and connecting the processing nodes with weights derived from coefficients of the hyperplanes;
analyse new test data points and compare their OVs with the Ovs of the train date points to classify the test data.
